(19) United States
(12) Patent Application Publication
(10) Pub. No.: US 2020/0099804 A1
(43) Pub. Date: Mar. 26, 2020

(54) DESIGN ASSISTING DEVICE AND NON-TRANSITORY COMPUTER READABLE MEDIUM

(71) Applicant: FUJI XEROX CO., LTD., Tokyo (JP)

(72) Inventor: Kazuhisa IWASE, Kanagawa (JP)

(73) Assignee: FUJI XEROX CO., LTD., Tokyo (JP)

(21) Appl. No.: 16/274,249

(22) Filed: Feb. 13, 2019

(30) Foreign Application Priority Data
Sep. 21, 2018 (JP) 2018-177862

(51) Int. Cl. H04N 1/00; G06F 3/06

(52) U.S. Cl. CPC H04N 1/00413; G06F 3/0671; H04N 1/00013

(57) ABSTRACT

A design assisting device includes a selecting unit and a display. The selecting unit selects, from among existing components that fit a specification required for a design target component, taking into consideration procurement information of the existing components, a target component candidate, which is a candidate for the target component, and selects, from among existing components that fit a specification required for a related component related to the target component, taking into consideration procurement information of the existing components, a related component candidate, which is a candidate for the related component. The display displays the target component candidate and the related component candidate.

### CROSS-REFERENCE TO RELATED APPLICATIONS

This application is based on and claims priority under 35 USC 119 from Japanese Patent Application No. 2018-177862 filed Sep. 21, 2018.

### BACKGROUND

### (i) Technical Field

The present disclosure relates to a design assisting device and a non-transitory computer readable medium.

### (ii) Related Art

In recent years, devices that are capable of formalizing a design procedure and improving commonization of components have been suggested.

A device described in Japanese Unexamined Patent Application Publication No. 7-105244 comprises database means for storing the relationship of an existing component and an attribute of the existing component, means for extracting, from input information on a design specification of a design target component, a necessary attribute required for the design target component, search means for searching, based on the extracted necessary attribute, the database means for an existing component that fits the necessary attribute, and designing means for designing, in the case where the search means is not able to find an existing component that fits the necessary attribute, a new component that satisfies the necessary attribute by combining a plurality of existing components.

### SUMMARY

For creation of drawings, a designer may perform designing by using an existing component with a high procurement cost or an old existing component that is not traded any more. In such a case, a high procurement cost or ending of trade may be found only when the designer tries to procure the component, and the designer may need to perform designing again. In the case where a design target component is related to another component, the designer may need to perform designing including the related component again.

Aspects of non-limiting embodiments of the present disclosure relate to providing a design assisting device and the like that are capable of performing designing taking into consideration procurement information of an existing component.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a design assisting device including a selecting unit and a display. The selecting unit selects, from among existing components that fit a specification required for a design target component, taking into consideration procurement information of the existing components, a target component candidate, which is a candidate for the target component, and selects, from among existing components that fit a specification required for a related component related to the target component, taking into consideration procurement information of the existing components, a related component candidate, which is a candidate for the related component. The display displays the target component candidate and the related component candidate.

### BRIEF DESCRIPTION OF THE DRAWINGS

Exemplary embodiments of the present disclosure will be described in detail based on the following figures, wherein:

FIG. 1 is a diagram illustrating an example of a configuration of a design assisting system according to an exemplary embodiment;

FIG. 2 is a diagram illustrating an example of a configuration of a design assisting device;

FIG. 3 is a block diagram illustrating an example of a functional configuration of a design assisting device;

FIG. 4A is a diagram illustrating an example of a home screen;

FIG. 4B is a diagram illustrating an example of an input screen onto which specifications of a target component and a related component are to be input;

FIG. 5 is a diagram illustrating an example of existing components extracted by a target component extraction part and existing components extracted by a related component extraction part;

FIG. 6 is a diagram illustrating an example of procurement information on target extraction components;

FIG. 7 is a diagram illustrating an example of a candidate list;

FIG. 8 is a diagram illustrating an example of a candidate list displayed on a display;

FIG. 9 is a flowchart illustrating a diversion examination process performed by a diversion examination assisting unit;

FIG. 10 is a flowchart illustrating a candidate list creation process performed by a candidate list creation part;

FIG. 11 is a diagram illustrating an example of three-dimensional data of a target component and a related component displayed on the display; and

FIG. 12 is a diagram illustrating an example of two-dimensional data of a target component and a related component displayed on the display.

### DETAILED DESCRIPTION

Hereinafter, exemplary embodiments will be explained in detail with reference to attached drawings.

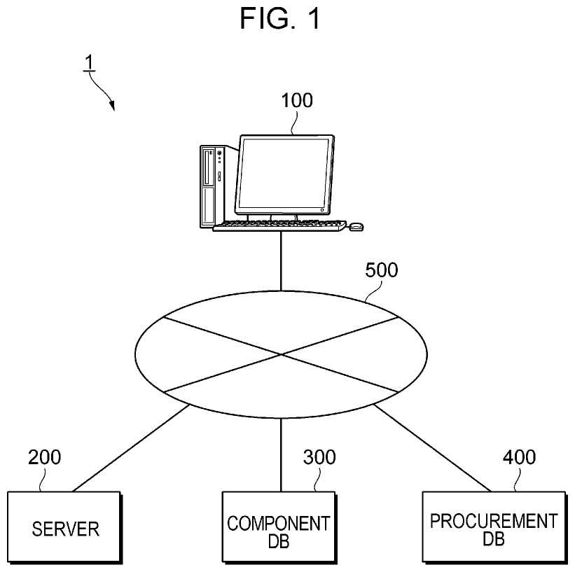

FIG. 1 is a diagram illustrating an example of a configuration of a design assisting system 1 according to an exemplary embodiment.

The design assisting system 1 according to this exemplary embodiment includes, as illustrated in FIG. 1, a design assisting device 100 that performs a two-dimensional or three-dimensional CAD application and a server 200 that stores two-dimensional or three-dimensional CAD data created using the CAD application of the design assisting device 100. The design assisting system 1 also includes a component database (DB) 300 that stores information on existing components and a procurement database (DB) 400 that stores procurement information of existing components.

The design assisting device 100, the server 200, the component DB 300, and the procurement DB 400 are capable of communicating with one another via a network 500. The network 500 is not particularly limited as long as it is a communication network used for data communication between systems and devices and may be, for example, a local area network (LAN), a wide area network (WAN), or the Internet. A communication line used for data communication may be wired or wireless, and both wired and wireless communication lines may be used. Furthermore, a relay device such as a gateway device or a router may be used so that devices may be connected via a plurality of networks or communication lines.

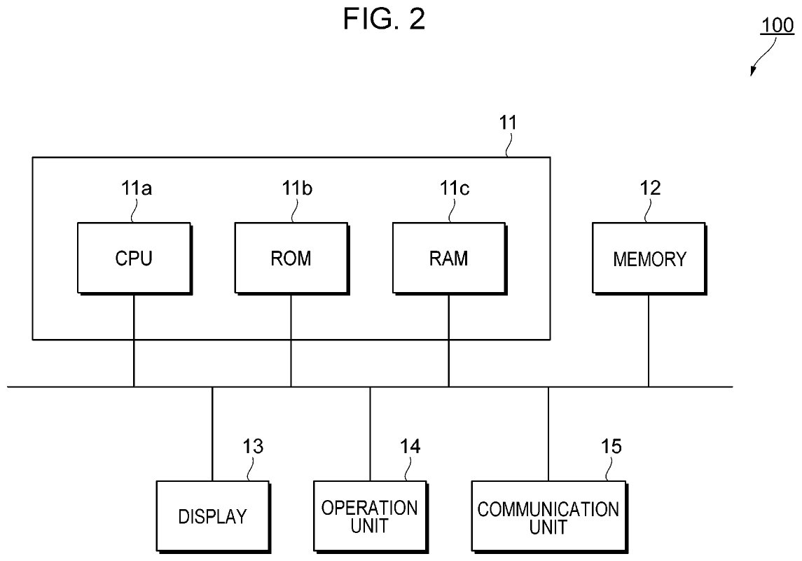

FIG. 2 is a diagram illustrating an example of a configuration of the design assisting device 100.

The design assisting device 100 includes a controller 11 that controls the entire device, a memory 12 that is used for storing data and the like, a display 13 that is used for displaying an operation reception screen and an image, an operation unit 14 that receives an input operation by a user, and a communication unit 15 that is used for communication with an external device.

The controller 11 includes a central processing unit (CPU) 11a, a read only memory (ROM) 11b, and a random access memory (RAM) 11c. A basic program (operation system) to be executed by the CPU 11a, various settings, and the like are stored in the ROM 11b. The CPU lla uses the RAM 11c as an operation area to execute an application program read from the ROM 11b or the memory 12. When the CPU 11a executes a program, individual units of a user terminal are controlled.

The memory 12 may be, for example, a memory unit such as a semiconductor memory or a hard disk drive (HDD).

The display 13 is a display unit that displays static images, moving images, and the like. The display 13 may be, for example, a liquid crystal display or an organic electroluminescence (EL) display.

The operation unit 14 is an input unit that receives an operation from a user. The operation unit 14 may be, for example, a keyboard, a mouse, a touch panel, a switch, and the like.

The communication unit 15 may be, for example, a communication interface.

The design assisting device 100 configured as described above may be, for example, a terminal dedicated to CAD. Furthermore, the design assisting device 100 may be a desktop PC, a notebook PC, or the like.

Each of the server 200, the component DB 300, and the procurement DB 400 includes a controller (not illustrated), a memory (not illustrated), a display (not illustrated), an operation unit (not illustrated), and a communication unit (not illustrated), which are similar to the controller 11, the memory 12, the display 13, the operation unit 14, and the communication unit 15 included in the design assisting device 100.

The component DB 300 stores information on existing components that have been procured as components. An existing component is a product that is procured or has been procured from a component supplier and is not necessarily limited to one object. For example, in the case where a plurality of objects are put together into a unit component as a procurement (trade) target, the unit component is stored as an existing component. A unit component formed of a plurality of objects may be, for example, composed of a resin spur gear and a metal ring fitted to an inner circumferential surface of the spur gear. The component DB 300 stores a specification and the like of an existing component in association with a component number of the existing component.

The procurement DB 400 stores information regarding procurement of an existing component, such as a retailer (supplier name), a unit price, and information of whether or not the component is able to be purchased, in association with a component number of the existing component.

The component DB 300 and the procurement DB 400 may be integrated with each other.

### <Diversion Examination Assisting Function of Design Assisting Device>

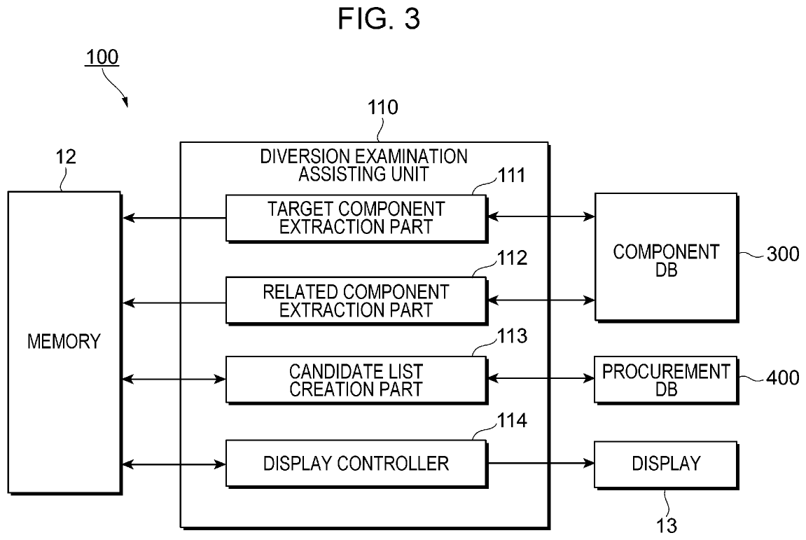

FIG. 3 is a block diagram illustrating an example of a functional configuration of the design assisting device 100.

The design assisting device 100 includes a diversion examination assisting unit 110 that assists examination regarding diversion of an existing component.

The diversion examination assisting unit 110 includes a target component extraction part 111 that extracts an existing component fitting a specification required for a design target component and a related component extraction part 112 that extracts an existing component fitting a specification required for a related component related to the target component. A specification may be, for example, at least one of the shape and material of a component.

The diversion examination assisting unit 110 also includes a candidate list creation part 113 that creates a list of combinations of a candidate for a target component selected from among existing components extracted by the target component extraction part 111 (hereinafter, may be referred to as a “target component candidate”) and a candidate for a related component selected from among existing components extracted by the related component extraction part 112 (hereinafter, may be referred to as a “related component candidate”).

The diversion examination assisting unit 110 also includes a display controller 114 that causes the list of combinations of a target component candidate and a relate component candidate created by the candidate list creation part 113 to be displayed on the display 13 in a predetermined order.

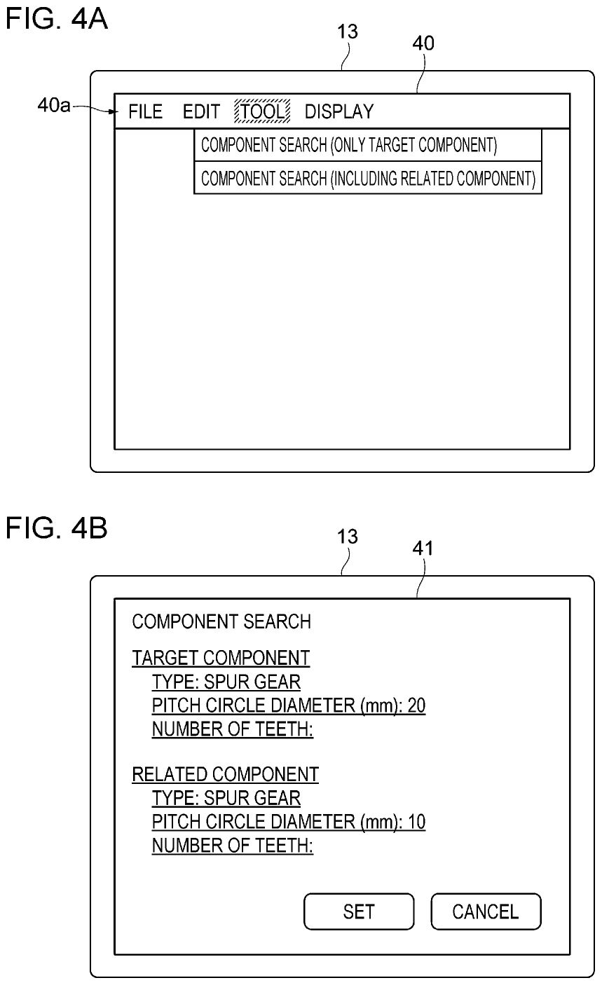

FIG. 4A is a diagram illustrating an example of a home screen 40. FIG. 4B is a diagram illustrating an example of an input screen 41 onto which specifications of a target component and a related component are to be input.

When a CAD application is booted, the design assisting device 100 causes the home screen 40 illustrated in FIG. 4A to be displayed on the display screen of the display 13. The home screen 40 also serves as a screen to be displayed on the display 13 for creation of CAD data. A menu bar 40a, which is a menu usable in this application, indicating “File”, “Edit”, “Tool”, and “Display”, is provided in an upper part of the home screen 40. When the “Tool” menu in the menu bar 40a is clicked, the design assisting device 100 displays buttons indicating “Component search (only target component)” and “Component search (including related component)”.

When the button indicating “Component search (including related component)” is clicked, the design assisting device 100 causes the input screen 41 illustrated in FIG. 4B to be displayed on the display 13. A designer inputs specifications of a target component and a related component onto the input screen 41 illustrated in FIG. 4B. In FIG. 4B, a case where a designer inputs “spur gear” as a type and “20 (mm)” as a pitch circle diameter for the specification of the target component and inputs “spur gear” as a type and “10 (mm)” as a pitch circle diameter for the specification of the related component, is illustrated.

Furthermore, the operation unit 14 may include a dedicated switch or button for displaying the input screen 41 so that the input screen 41 may be displayed on the display 13 when the designer operates the switch or the button.

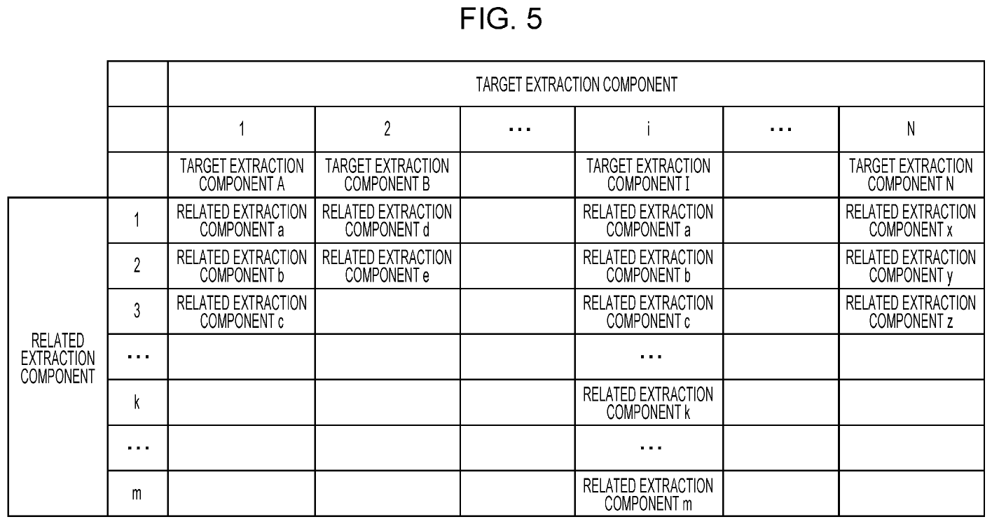

FIG. 5 is a diagram illustrating an example of existing components extracted by the target component extraction part 111 and existing components extracted by the related component extraction part 112.

The target component extraction part 111 extracts an existing component that fits a specification of a target component input onto the input screen 41, from among existing components stored in the component DB 300. Hereinafter, an extracted existing component that fits a specification of a target component may be referred to as a “target extraction component”. In the example illustrated in FIG. 5, N target extraction components A to N are extracted.

The related component extraction part 112 extracts an existing component that fits a specification of a related component input onto the input screen 41 and that is able to be used in combination with a target extraction component, from among existing components stored in the component DB 300. Hereinafter, an extracted existing component that fits a specification of a related component may be referred to as a “related extraction component”.

First, the related component extraction part 112 extracts an existing component that fits a specification of a related component input onto the input screen 41 from among existing components stored in the component DB 300. Then, the related component extraction part 112 determines whether or not the extracted existing component is able to be used in combination with a target extraction component. In the case where the extracted existing component is able to be used in combination with a target extraction component, the related component extraction part 112 extracts the extracted existing component as a related extraction component. For example, in the example illustrated in FIGS. 4A and 4B in which a “spur gear” is input, an existing component that fits a specification of a related component but does not correspond to a module of a target extraction component is determined not to be able to be used in combination with the target extraction component and is thus not be extracted. A basis for making a determination as to whether or not an extracted existing component is able to be used in combination with a target extraction component may be set in advance according to the type of component. For example, a module may serve as a basis for making a determination for gears and a pitch may serve as a basis for making a determination for a bolt and a nut.

In the example illustrated in FIG. 5, a related extraction component a, a related extraction component b, and a related extraction component c are extracted as related extraction components that are able to be used in combination with a target extraction component A.

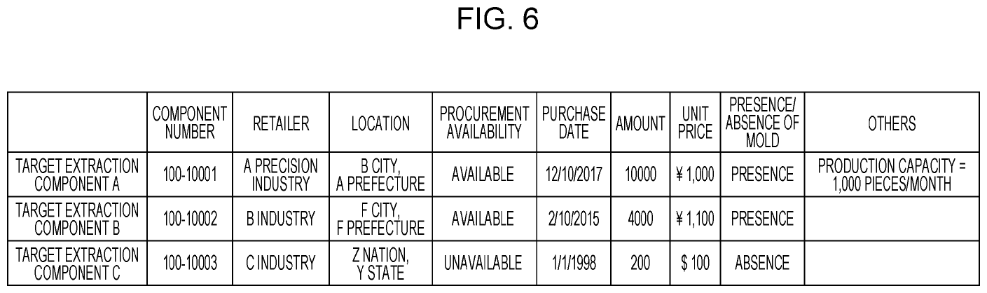

FIG. 6 is a diagram illustrating an example of procurement information on a target extraction component.

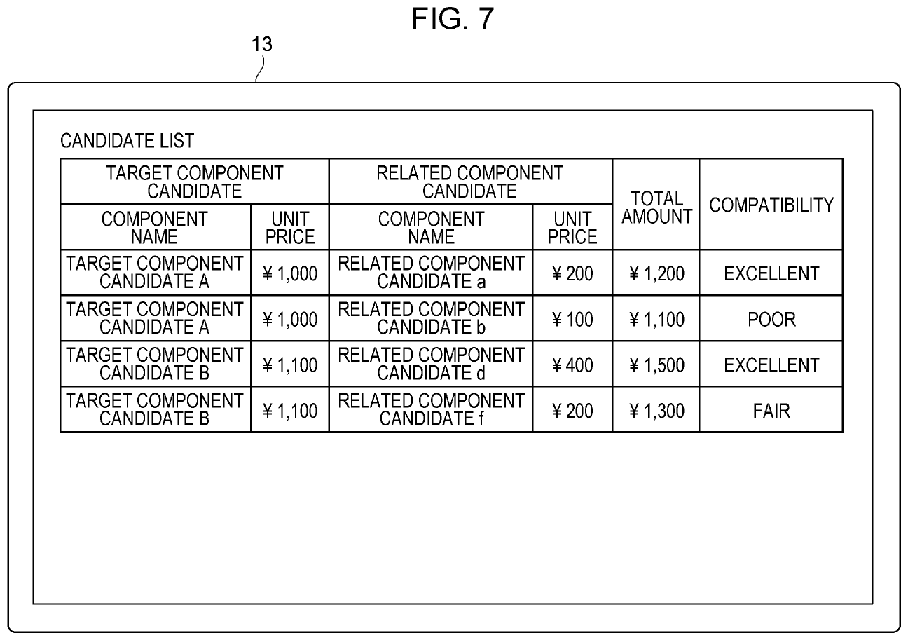

FIG. 7 is a diagram illustrating an example of a candidate list.

The candidate list creation part 113 acquires from the procurement DB 400 procurement information on target extraction components extracted by the target component extraction part 111. Then, the candidate list creation part 113 selects, as a target component candidate, a target extraction component that is able to be procured, from among the target extraction components. As illustrated in FIG. 6, for example, in the case where, out of the target extraction components A to C extracted by the target component extraction part 111, the target extraction component A and the target extraction component B are able to be procured and the target extraction component C is not able to be procured, the target extraction components A and B are selected as target component candidates.

In a similar manner, the candidate list creation part 113 acquires from the procurement DB 400 procurement information on related extraction components extracted by the related component extraction part 112. Then, the candidate list creation part 113 selects, as a related component candidate, a related extraction component that is able to be procured, from among the extracted related extraction components.

Then, as illustrated in FIG. 7, the candidate list creation part 113 creates a candidate list including the total amount of money and compatibility of each of the combinations of a target component candidate and a related component candidate. The compatibility of a target component candidate and a related component candidate may be set in advance according to the type of component. Furthermore, compatibility may be evaluated in stages. For example, for a combination of spur gears, by taking the quality of material as an index, the compatibility of a resin gear and a metal gear may be evaluated to be high, whereas the compatibility of a resin gear and a resin gear and the compatibility of a metal gear and a metal gear may be evaluated to be moderate. Furthermore, for a combination of a bolt and a nut, by taking the strength as an index, the compatibility of a bolt and a nut whose strengths are recommended by JIS B 1052-2 may be evaluated to be high and the compatibility of a bolt and a nut whose strengths are not recommended by JIS B 1052-2 may be evaluated to be low. Furthermore, the candidate list creation part 113 may evaluate the compatibility of a combination with strengths equal to or more than an upper limit value defined in advance by simulation to be high, evaluate the compatibility of a combination with strengths lower than a lower limit value defined in advance to be low, and evaluate the compatibility of a combination with strengths higher than or equal to the lower limit value and lower than the upper limit value to be moderate.

In the example illustrated in FIG. 7, high compatibility is indicated by “Excellent”, moderate compatibility is indicated by “Fair”, and low compatibility is indicated by “Poor”.

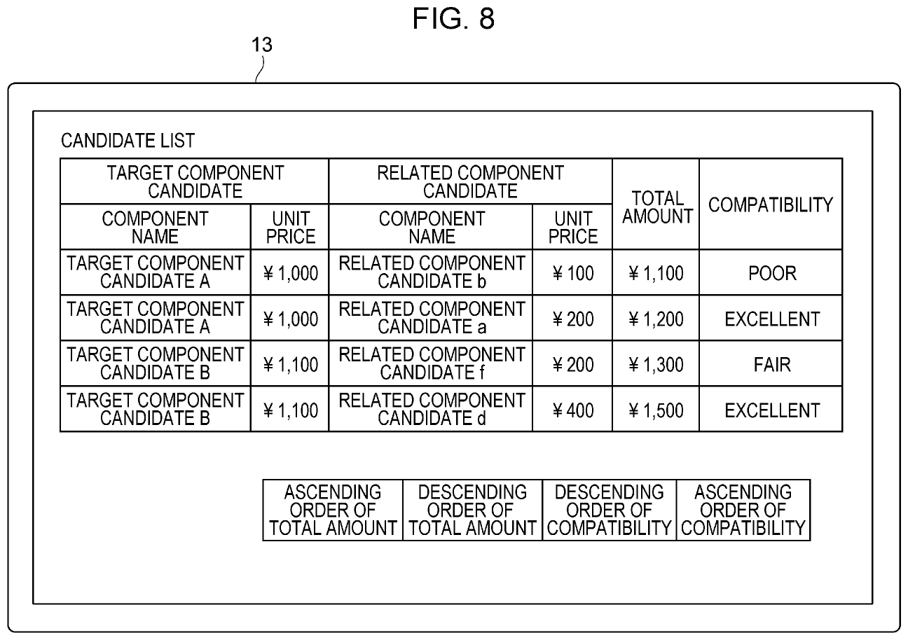

FIG. 8 is a diagram illustrating an example of a candidate list displayed on the display 13.

The display controller 114 causes a candidate list created by the candidate list creation part 113 to be displayed on the display 13 in a predetermined order.

The predetermined order may be, for example, an order according to the total amount of money. The order according to the total amount of money may be, for example, an ascending order of total amount of money, as illustrated in FIG. 8. In contrast, the order according to the total amount of money may be a descending order of total amount of money. Alternatively, the predetermined order may be, for example, an order according to the compatibility of a target component candidate and a related component candidate. The order according to the compatibility may be, for example, a descending order of compatibility. In contrast, the order according to the compatibility may be an ascending order of compatibility.

Furthermore, selectable buttons may be displayed so that a designer is able to select an order, as illustrated in FIG. 8.

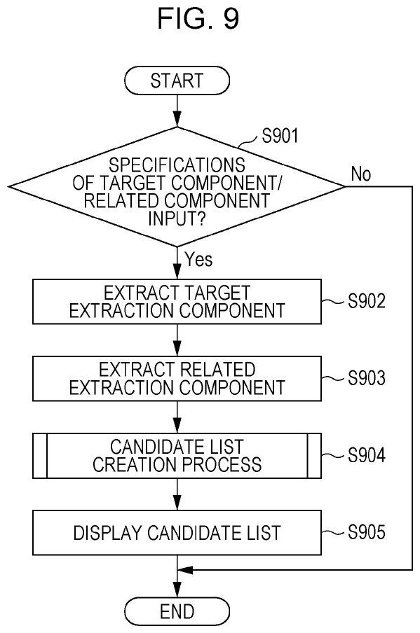

FIG. 9 is a flowchart illustrating a diversion examination process performed by the diversion examination assisting unit 110. The diversion examination assisting unit 110 repeatedly performs this selling and buying process every preset time (for example, one millisecond).

The diversion examination assisting unit 110 determines whether or not specifications of a target component and a related component are input onto the input screen 41 described above (S901). In the case where specifications of a target component and a related component are input (Yes in S901), the diversion examination assisting unit 110 extracts an existing component (target extraction component) that fits the specification required for the target component from the component DB 300, and causes the extracted existing component (target extraction component) to be stored in the memory 12 (S902). This processing is performed by the target component extraction part 111.

Then, the diversion examination assisting unit 110 extracts an existing component (related extraction component) that fits the specification required for the related component from the component DB 300, and causes the extracted existing component (related extraction component) to be stored in the memory 12 (S903). This processing is performed by the related component extraction part 112.

Then, the diversion examination assisting unit 110 performs a candidate list creation process (S904). This process is performed by the candidate list creation part 113.

Then, the diversion examination assisting unit 110 causes the candidate list created in the candidate list creation process to be displayed on the display 13 (S905). This processing is performed by the display controller 114.

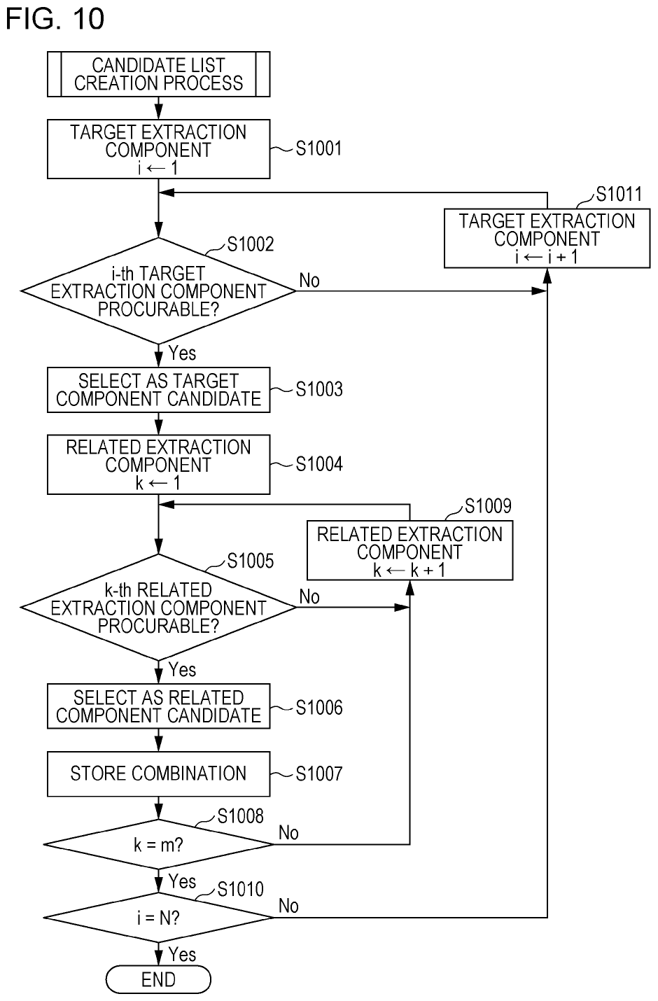

FIG. 10 is a flowchart illustrating a candidate list creation process performed by the candidate list creation part 113. The candidate list creation part 113 repeatedly performs the candidate list creation process every preset time (for example, one millisecond).

In the candidate list creation process illustrated in FIG. 10, the candidate list creation part 113 extracts m related extraction components for the i-th target extraction component out of N target extraction components. Any combination of the i-th target extraction component and m related extraction components is possible. In the example illustrated in FIG. 5, a related extraction component a, a related extraction component b, and a related extraction component c are defined as related extraction components that are related to the first target extraction component A.

The candidate list creation part 113 sets an order i for the N target extraction components to 1 (S1001). Then, the candidate list creation part 113 determines whether or not the i-th target extraction component is able to be procured (S1002). In the case where the i-th target extraction component is able to be procured (Yes in S1002), the candidate list creation part 113 selects the i-th target extraction component as a target component candidate (S1003). Then, the candidate list creation part 113 sets an order k for the related extraction components that are related to the i-th target extraction component to 1 (S1004). Then, the candidate list creation part 113 determines whether or not the k-th related extraction component is able to be procured (S1005). In the case where the k-th related extraction component is able to be procured (Yes in S1005), the candidate list creation part 113 selects the related extraction component a as a related component candidate (S1006). Then, the candidate list creation part 113 causes the combination of the target component candidate and the related component candidate to be stored, along with corresponding unit prices (S1007). At this time, the candidate list creation part 113 also causes the total amount of money of the unit price of the target component candidate and the unit price of the related component candidate and the compatibility of the target component candidate and the related component candidate to be stored.

After that, the candidate list creation part 113 determines whether or not the order k for the related extraction components has reached the number m of extracted related extraction components (S1008). In the case where the order k has not reached the number m of extracted related extraction components (No in S1008), the candidate list creation part 113 sets the order k for the related extraction components to a value obtained by incrementing the current order k by 1 (k k+1) (S1009). Then, the candidate list creation part 113 performs processing of S1005 and later processing. As described above, the processing of S1005 to S1009 is repeatedly performed until the order k for the related extraction components has reached the number m of extracted related extraction components.

In the case where the order k has reached the number m of extracted related extraction components (Yes in S1008), the candidate list creation part 113 determines whether or not the order i for the target extraction components has reached the number N of extracted target extraction components (S1010). In the case where the order i has not reached the number N of extracted target extraction components (No in S1010), the candidate list creation part 113 sets the order i for the target extraction components to a value obtained by incrementing the current order i by 1 (i→i+1) (S1011). Then, the candidate list creation part 113 performs processing of S1002 and later processing. As described above, processing of S1002 to S1010 is repeatedly performed until the order i for the target extraction components has reached the number N of extracted target extraction components.

When the candidate list creation part 113 performs the candidate list creation process, a candidate list in which a combination of a target component candidate and a related component candidate is associated with the total amount of money of the unit price of the target component candidate and the unit price of the related component candidate and the compatibility of the target component candidate and the related component candidate is created, and is stored in the memory 12.

Then, the display controller 114 causes the candidate list to be displayed on the display 13 (S905).

When the candidate list is displayed on the display 13, the designer is able to select a combination of a target component candidate and a related component candidate.

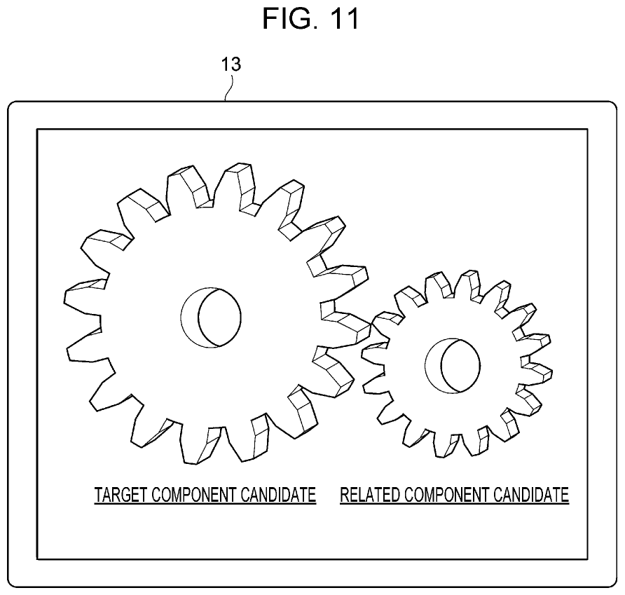

FIG. 11 is a diagram illustrating an example of three-dimensional data of a target component and a related component displayed on the display 13.

In the case where a designer selects one of combinations in a candidate list displayed on the display 13, the design assisting device 100 may cause three-dimensional CAD data of the selected target component candidate and related component candidate to be displayed on the display 13, as illustrated in FIG. 11. Accordingly, the designer is able to know the details of the target component candidate and the related component candidate. Furthermore, the designer is be able to design other components around the target component candidate and the related component candidate. Two-dimensional CAD data may be displayed on the display 13.

As described above, the design assisting device 100 according to this exemplary embodiment includes the diversion examination assisting unit 110 as an example of a selecting unit that selects, from among existing components that fit a specification required for a design target component, taking into consideration procurement information of the existing components, a target component candidate, which is a candidate for the target component, and selects from among existing components that fit a specification required for a related component related to the target component, taking into consideration procurement information of the existing components, a related component candidate, which is a candidate for the related component. The design assisting device 100 also includes the display 13 that displays the target component candidate and the related component candidate. A designer is able to set an existing component that is to be diverted as a target component from among target component candidates displayed on the display 13. Furthermore, the designer is able to set an existing component that is to be diverted as a related component from among related component candidates displayed on the display 13. The diversion examination assisting unit 110 does not select, for example, existing components that are not currently traded and difficult to be procured as a target component candidate and a related component candidate, and therefore, a situation in which the designer performs designing by using a component that is difficult to be procured may be reduced. As a result, a situation in which difficulty in procurement of a designed component is found only when the designer tries to procure the component and the designer needs to perform designing again may be reduced.

The display 13 in the exemplary embodiment described above displays a combination of a target component candidate and a related component candidate. Accordingly, the designer is able to set a combination of an existing component that is to be diverted as a target component and an existing component that is to be diverted as a related component, from among displayed combinations. Therefore, the design assisting device 100 according to this exemplary embodiment allows the designer to easily set an existing component to be diverted as a target component and an existing component to be diverted as a related component.

The display 13 may display, for example, combinations of a target component candidate and a related component candidate in an order of total amount of money, which is the total price of a target component candidate and a related component candidate. For example, when the total amount of money is displayed in an ascending order on the display 13, the designer is able to easily select a combination with a low total amount of money. Accordingly, an increase in the cost of a product using these components is suppressed. In contrast, when the total amount of money is displayed in a descending order on the display 13, the designer is able to be informed of a bad design example with a high unit price of a component. Accordingly, the designer is able to refer to the bad design example when designing other components.

Furthermore, the display may display, for example, combinations of a target component candidate and a related component candidate in an order of the compatibility of combination. For example, when combinations are displayed in a descending order of compatibility on the display 13, the designer is able to easily make a selection with an increased product durability, an increased merchantability regarding noise, and the like. In contrast, when combinations are displayed in an ascending order of compatibility on the display 13, the designer is able to be informed of a design example with a poor compatibility and is thus able to refer to the design example when designing other components.

The diversion examination assisting unit 110 understands a specification required for a target component and a specification required for a related component taking into consideration information input by a designer. Accordingly, the diversion examination assisting unit 110 is prevented from wrongly understanding a specification required for a target component and a specification required for a related component.

Furthermore, the diversion examination assisting unit 110 may select a target component candidate while understanding a specification of a target component taking into consideration information input by a designer and select a related component candidate that fits the specification of the target component candidate. Accordingly, the designer is able to select a target component candidate and a related component candidate that are able to be combined in terms of specifications.

The processes described above that are performed by the controller 11 of the design assisting device 100 may be implemented when software and hardware resources cooperate. In this case, the CPU of the controller 11 executes a program for implementing each function of the controller 11 so that the function may be implemented. For example, a non-transitory computer-readable recording medium in which a program is recorded is supplied to the controller 11, and the CPU reads the program stored in the recording medium. In this case, the program itself read from the recording medium implements a function of the foregoing exemplary embodiment, and the program itself and the recording medium in which the program is recorded form an exemplary embodiment of the present disclosure. For example, a flexible disk, a compact disc-read only memory (CD-ROM), a digital versatile disc-read only memory (DVD-ROM), a hard disk, an optical disk, a magneto-optical disk, a compact disc-recordable (CD-R), a magnetic tape, a nonvolatile memory card, or a ROM may be used as a recording medium for supplying such a program. Furthermore, the program may be downloaded into the design assisting device 100 via the network 500.

A non-transitory computer readable medium forming an exemplary embodiment of the present disclosure causes a computer to execute a process including selecting, from among existing components that fit a specification required for a design target component, taking into consideration procurement information of the existing components, a target component candidate, which is a candidate for the target component, and selecting, from among existing components that fit a specification required for a related component related to the target component, taking into consideration procurement information of the existing components, a related component candidate, which is a candidate for the related component, and displaying the target component candidate and the related component candidate.

(Modification about Specification of Target Component and Related Component)

In the foregoing exemplary embodiment, the diversion examination assisting unit 110 specifies specifications of a target component and a related component, based on items input onto the input screen 41. However, the present disclosure is not limited to the foregoing exemplary embodiment.

With the diversion examination assisting unit 110, a designer may specify specifications of a target component and a related component, based on two-dimensional or three-dimensional CAD data of the target component and the related component displayed on the display 13.

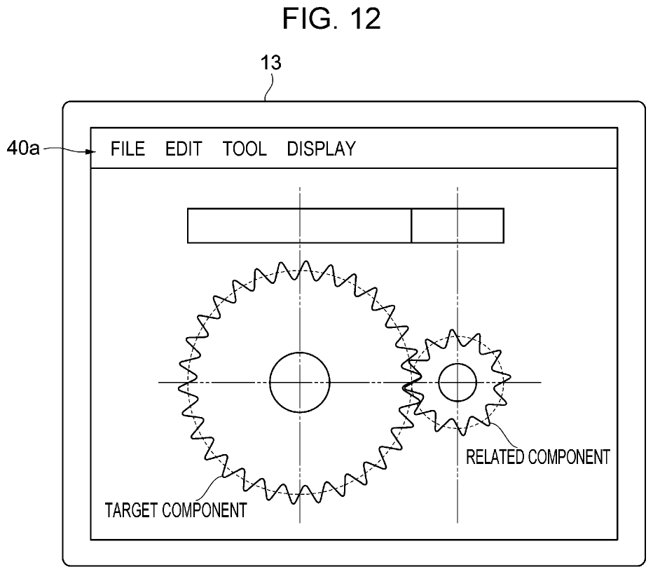

FIG. 12 is a diagram illustrating an example of two-dimensional data of a target component and a related component displayed on the display 13. In the example illustrated in FIG. 12, a front view of a combination of a target component, which is a spur gear, and a related component, which is a spur gear that fits into the target component, is displayed at the center of the display screen of the display 13, and a diagram of the combination viewed from above is displayed in an upper part of the display screen.

In the case where a designer clicks the button indicating “Component search (including related component)” in the “Tool” menu of the menu bar 40a and then selects, for example, the two-dimensional data illustrated in FIG. 12, the target component extraction part 111 may specify the selected item as a target component. The target component extraction part 111 may understand the specification of the target component based on the selected two-dimensional data.

The target component extraction part 111 may specify three-dimensional data (3D model) selected by the designer as a target component and then understand the specification of the target component based on the selected three-dimensional data.

The related component extraction part 112 specifies, based on CAD data of the specified target component, a related component related to the target component. The related component extraction part 112 may specify, for example, at least one of (1) a component adjacent to the target component, (2) a component in contact with the target component, and (3) a component having gravity center coordinates within a predetermined range relative to the gravity center coordinates of the target component on the CAD data as a related component. In the example illustrated in FIG. 12, conditions of (1) the component adjacent to the target component and (2) the component in contact with the target component described above are satisfied. Therefore, the related component extraction part 112 specifies, as a related component, the spur gear that fits into the spur gear as the target component.

For example, a component that corresponds to (3) described above may be a shaft at which a spur gear as a target component is to be mounted.

Before specifying a component that corresponds to at least one of the conditions of (1) to (3) described above as a related component, the related component extraction part 112 may highlight a component that corresponds to each condition and query a designer about whether the highlighted component may be specified as a related component. A method for making an inquiry is not particularly limited. For example, a wording “Are you sure that the highlighted component will be specified as a related component?” and buttons indicating “Yes” and “No” may be displayed on the display screen of the display 13. When the designer clicks the button indicating “Yes” while the cursor is being placed on the button, the highlighted component may be specified as a related component.

Furthermore, conditions for specifying a component as the related component described above are not limited to (1) to (3) described above.

Furthermore, after the designer clicks the button indicating “Component search (including related component)” in the “Tool” menu of the menu bar 40a, the related component extraction part 112 may specify, as a related component, a component regarding the second selected two-dimensional data or three-dimensional data (a component regarding the first selected two-dimensional data is specified as a target component).

As described above, the diversion examination assisting unit 110 understands a specification required for a target component and a specification required for a related component taking into consideration CAD data, which is an example of information selected by a designer. Accordingly, the diversion examination assisting unit 110 may be prevented from wrongly understanding a specification required for a target component and a specification required for a related component.

Furthermore, the diversion examination assisting unit 110 may understand a specification required for a target component and a specification required for a related component, based on three-dimensional model (3D model) created by the designer. Accordingly, a difference between specifications actually required for a target component and a related component by the designer and specifications required for a target component and a related component understood by the diversion examination assisting unit 110 becomes smaller. Therefore, the diversion examination assisting unit 110 may be prevented from wrongly understanding specifications required for target and related components.

(Modification about Display of Only Target Component Candidate)

In the foregoing exemplary embodiment, a list of combinations of a target component candidate and a related component candidate is displayed on the display 13. However, the present disclosure is not particularly limited to the above aspect.

The diversion examination assisting unit 110 may display a list of only target component candidates. For example, when a designer inputs a specification of only a target component on the input screen 41 illustrated in FIG. 4B (or an input screen displayed when the button indicating “Component search (only target component)” in the “Tool” menu of the menu bar 40a is clicked), the target component extraction part 111 extracts an existing component that fits the specification of the target component input onto the input screen 41 from among existing components stored in the component DB 300. Then, the candidate list creation part 113 may acquire from the procurement DB 400 procurement information of target extraction components extracted by the target component extraction part 111 and select, as a target component candidate, a target extraction component that is able to be procured from among the target extraction components. Then, the candidate list creation part 113 may create a list including information of target component candidates and unit prices of the target component candidates, and the display controller 114 may cause the candidate list to be displayed on the display 13.

Then, when the designer selects one of the target component candidates in the list of the target component candidates displayed on the display 13, the design assisting device 100 may cause two-dimensional or three-dimensional CAD data of the selected target component candidate to be displayed on the display 13. Accordingly, the designer is able to know the details of the target component candidate. Furthermore, the designer is able to design other components around the target component candidate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. A design assisting device comprising a display and a hardware processor, wherein the hardware processor is configured to:
receive a specification required for a design target component and a specification required for a related component;
select, from among existing components that fit the specification required for the design target component, taking into consideration the procurement information of the existing components, a target component candidate, which is a candidate for the target component;
select, from among existing components that fit the specification required for the related component related to the target component, taking into consideration the procurement information of the existing components, a related component candidate, which is a candidate for the related component;
create a candidate list that includes the target component candidate, the related component candidate, a compatibility of a combination of the target component candidate and the related component candidate, and a procurement cost information of the combination of the target component candidate and the related component candidate; and
control the display to display the candidate list on the display.

2. The design assisting device according to claim 1, wherein the display displays the combination of the target component candidate and the related component candidate.

3. The design assisting device according to claim 2, wherein the combination includes a plurality of combinations, and the display displays the combinations in an order of a total amount of money of the target component candidate and the related component candidate.

4. The design assisting device according to claim 2, wherein the combination includes a plurality of combinations, and the display displays the combinations in an order of compatibility of the combination.

5. The design assisting device according to claim 1, wherein the hardware processor understands the specification required for the target component and the specification required for the related component taking into consideration information input or selected by a designer.

6. The design assisting device according to claim 2, wherein the hardware processor understands the specification required for the target component and the specification required for the related component taking into consideration information input or selected by a designer.

7. The design assisting device according to claim 3, wherein the hardware processor understands the specification required for the target component and the specification required for the related component taking into consideration information input or selected by a designer.

8. The design assisting device according to claim 4, wherein the hardware processor understands the specification required for the target component and the specification required for the related component taking into consideration information input or selected by a designer.

9. The design assisting device according to claim 5, wherein the hardware processor selects the target component candidate while understating the specification of the target component taking into consideration the information input or selected by the designer and selects the related component candidate that fits the specification of the target component candidate.

10. The design assisting device according to claim 6, wherein the hardware processor selects the target component candidate while understating the specification of the target component taking into consideration the information input or selected by the designer and selects the related component candidate that fits the specification of the target component candidate.

11. The design assisting device according to claim 7, wherein the hardware processor selects the target component candidate while understating the specification of the target component taking into consideration the information input or selected by the designer and selects the related component candidate that fits the specification of the target component candidate.

12. The design assisting device according to claim 8, wherein the hardware processor selects the target component candidate while understating the specification of the target component taking into consideration the information input or selected by the designer and selects the related component candidate that fits the specification of the target component candidate.

13. The design assisting device according to claim 1, wherein the hardware processor understands the specification required for the target component and the specification required for the related component, based on three-dimensional model created by a designer.

14. The design assisting device according to claim 2, wherein the hardware processor understands the specification required for the target component and the specification required for the related component, based on three-dimensional model created by a designer.

15. The design assisting device according to claim 3, wherein the hardware processor understands the specification required for the target component and the specification required for the related component, based on three-dimensional model created by a designer.

16. The design assisting device according to claim 4, wherein the hardware processor understands the specification required for the target component and the specification required for the related component, based on three-dimensional model created by a designer.

17. A method, comprising:
receiving a specification required for a design target component and a specification equired for a related component;
selecting, from among existing components that fit the specification required for the design target component, taking into consideration procurement information of the existing components, a target component candidate, which is a candidate for the target component;
selecting, from among existing components that fit the specification required for the related component related to the target component, taking into consideration the procurement information of the existing components, a related component candidate, which is a candidate for the related component;
creating a candidate list that includes the target component candidate, the related component candidate, a compatibility of a combination of the target component candidate and the related component candidate, and a procurement cost information of the combination of the target component candidate and the related component candidate; and
controlling a display to display the candidate list on the display.

18. A non-transitory computer readable medium storing a program causing a computer to execute a process for design assistance, the process comprising:
receiving a specification required for a design target component and a specification required for a related component;
selecting, from among existing components that fit the specification required for the design target component, taking into consideration the procurement information of the existing components, a target component candidate, which is a candidate for the target component;
selecting, from among existing components that fit the specification required for the related component related to the target component, taking into consideration the procurement information of the existing components, a related component candidate, which is a candidate for the related component;
creating a candidate list that includes the target component candidate, the related component candidate, a compatibility of a combination of the target component candidate and the related component candidate, and a procurement cost information of the combination of the target component candidate and the related component candidate; and
controlling to a display to display the candidate list on the display.
